(19) United States
(12) Patent Application Publication
(10) Pub. No.: US 2013/0237282 A1
(43) Pub. Date: Sep. 12, 2013

(54) EAR PHONE CONTROLLER

(71) Applicant: JONATHAN GOTTEHRER, MASSAPEQUA, NY (US)

(72) Inventor: JONATHAN GOTTEHRER, MASSAPEQUA, NY (US)

(21) Appl. No.: 13/789,531

(22) Filed: Mar. 7, 2013

Related U.S. Application Data
(60) Provisional application No. 61/608,547, filed on Mar. 8, 2012.

(51) Int. Cl. H04M 1/60

(52) U.S. Cl. CPC H04M 1/6041
USPC 455/556.1; 455/563

(57) ABSTRACT

A cellular telephone operated only by voice control and having no keyboard or video display is disclosed. The cellular telephone is worn in, on or over the ear of the user, and control to operate the phone is delivered via voice commands to the boom microphone extending from the phone housing. Voice recognition software in the microprocessor translates the voice commands to signals that operate the phone to make calls, dial a phone number, retrieve a telephone number from memory and the like. A cloud based server with voice recognition software is accessed by the phone to transcribe incoming text messages and emails from a digital medium to audible language, and vice versa.

### CROSS-REFERENCE TO RELATED APPLICATION

This application claims priority from U.S. Provisional Patent Application No. 61/608,547, filed Mar. 8, 2012, which contents are hereby incorporated by reference in their entirety.

### FIELD OF THE INVENTION

The present invention is directed to a mobile or cellular telephone. More specifically, the present invention is directed to a mobile or cellular telephone entirely self-contained, mounted to the ear, and controlled by voice commands.

### BACKGROUND

Cellular telephones known and used present day became popular in the early 1980's. These devices could make and receive telephone calls over a radio network via cell towers in a wide geographic area. The early era cell phones contained physically large electronics and circuitry that had to be powered by a large battery and weighed several pounds. They were typically installed in automobiles before becoming small enough to be handheld and portable. See, for example, U.S. Pat. No. 3,906,166 (Cooper, et al.) and U.S. Pat. No. 3,663,762 (Joel). More recently, with the emergence of Bluetooth®, a wireless technology for short-wavelength radio transmissions over a short distance, enabled a lightweight microphone and ear piece that could be wirelessly tethered to the still relatively bulky and heavy cell phone, which could be carried in a purse or worn on a belt, etc. See, for example, U.S. Pat. No. 7,603,148 (Michalak). Conventional solutions have all focused on using Bluetooth® or like technologies to separate the microphone and ear piece from the heavy and bulky cell phone, so that the user can operate the cell phone hands-free. The hands-free aspect is popular among drivers trying to remain productive on their daily commutes, while making and receiving calls that abide by the hands-free driving laws.

### SUMMARY OF THE INVENTION

The present invention is directed to a cellular telephone worn on a user's head. The preferred embodiment cellular telephone has a unitary housing having a speaker engaging the user's ear canal, wherein the housing has no video display and no keypad. A boom extends from the housing, and has a distal end extending toward the user's mouth. A microphone is disposed at the distal end of the boom; an antenna extends along at least a portion of the boom. A transceiver is disposed within the housing connected to the antenna. A rechargeable battery is disposed within the housing to power the transceiver. A microprocessor including memory is disposed in the housing and is powered by the battery, and controls the transceiver, and interfaces with the speaker and microphone. Voice recognition means resident in the microprocessor that digitizes voice commands to a control signal for the microprocessor to control telephone functions. Optionally, the cellular telephone can access a cloud based server to transcribe incoming/outgoing emails, incoming/outgoing text messages, and the like.

### BRIEF DESCRIPTION OF THE DRAWINGS

FIG. 1 is a schematic of a preferred embodiment ear mounted cellular telephone.

FIG. 2 is a perspective view of the ear mounted cellular telephone of FIG. 1.

### DETAILED DESCRIPTION OF THE PREFERRED EMBODIMENTS

The present invention in a preferred embodiment is directed to a cellular telephone worn on a user's head, preferably on or over his or her ear, wherein the cellular telephone is entirely voice controlled so that dialing outgoing calls, receiving incoming calls, hanging up, etc. are all handled by voice control. Therefore, no keypad or video display is needed to operate the phone. Because the phone is entirely self-contained and supported by the user's ear, there is no need for Bluetooth® tethering for the ear piece and microphone to the main body of the cellular phone/radio. Of course, in an alternative embodiment, the cellular phone may include a Bluetooth® transceiver or other wireless means to tether to a display screen device or no display screen device to enable voice command to control its functioning.

The phone is capable of accessing a cloud based server using voice recognition so that incoming or outgoing emails, text messages and the like can be transcribed from voice to a digital medium and vice versa.

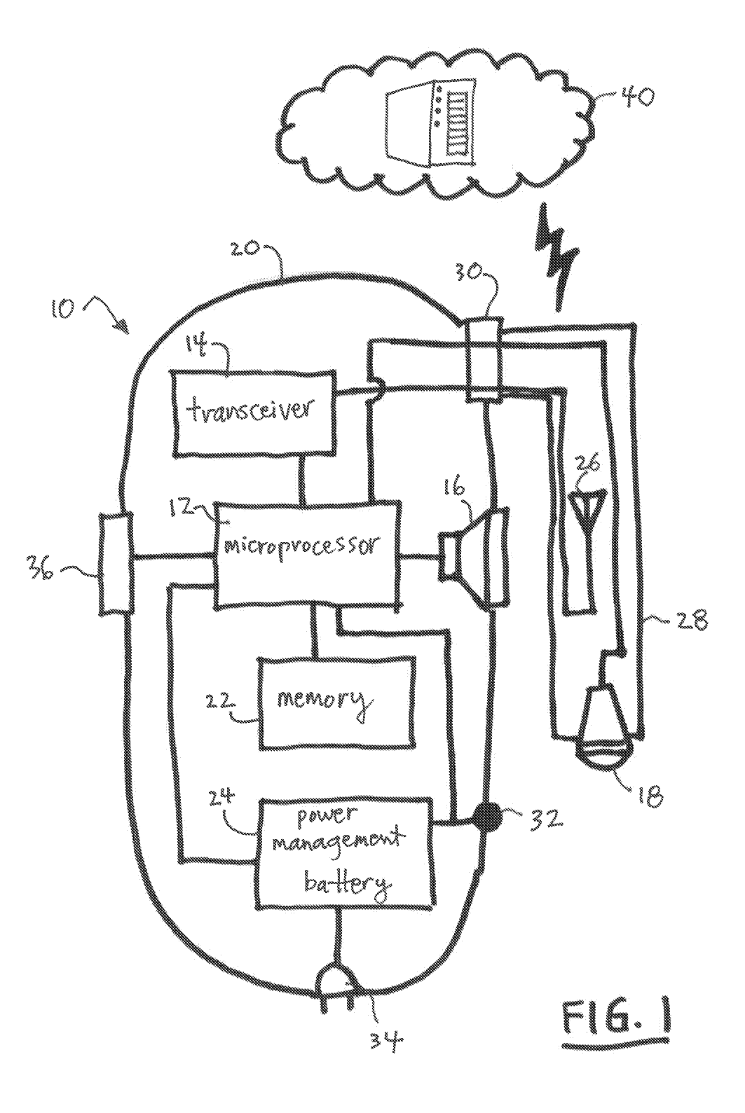

FIG. 1 is a simplified schematic diagram showing the basic construction of a preferred embodiment cellular telephone 10. Basic cellular telephone construction is well known in the art. Inside the housing 20, there is a microprocessor 12 includes a digital signal processor for A-to-D and D-to-A conversions for all of the analog components, such as the transceiver 14, speaker 16, and microphone 18. The microprocessor 12 controls all telephone functions, signal processing with the cell towers and base stations, etc. The memory 22 represents ROM and flash memory chips containing the cellular telephone's basic operating system phone identification codes, and may include SIM cards or smart media cards individualized to each user/cellular service subscriber.

The operating system for the phone has a platform whereby third party developers can create their own unique uses for the phone by profiting from a speech app store on the web, which is also accessible by voice through the phone.

The phone's telephone directory or contact list, user interface, help menu, etc. may be resident in the memory 22. A power supply/power management component including a rechargeable battery 24 is used to power the telephone 10. The transceiver module 14 uses an antenna 26 located inside a cantilevered boom 28 that extends from the housing 20. In an alternative embodiment, the transceiver module 14 can be located at the distal end of the boom 28, to mitigate possible hazardous radiation near the user's brain. The cantilevered boom 28 may be hinged to the housing 20 via optional swivel or hinged connection 30, where the electrical wiring can be by thin film flex cables. The boom 28 thus can be folded or collapsed to be more compact.

The microphone 18 is positioned at the distal end of the boom 28 and directed toward the user's mouth. A speaker or ear piece 16 fits into the user's ear canal and is controlled by the microprocessor 12 via amplifiers known in the art.

Around the exterior of the housing 20 are a power switch 32, a receptacle or port 34 for receiving DC power or via USB cable to charge the battery 24, and an optional LCD display 36 bearing simple icons to deliver basic phone information to the user such as phone on, cell signal strength, battery level, call connected/disconnected, and the like. In an alternative embodiment, it is possible to charge the battery 24 through induction to omit the power port 34. Such charging technology is well known and disclosed in, for example, U.S. Pat. No. 7,576,514 (Hui), titled “Planar Inductive Battery Charging System,” which contents are hereby incorporated by reference.

This LCD display 36 is not a high power consumption video display screen or traditional touch screen found on traditional cell phones that generate, for example, color graphics, video, etc. The power switch 32 may be a programmable, multi-function switch such that a longer press is for power on/off, and shorter press dials or hangs up on a single number. In an alternative embodiment, another control button or switch can be added to transfer calls to a speakerphone. The phone 10 can be attached via a clip to a car visor, seat belt, or clothing for use on or off of the ear, or placed on a surface. More buttons, slide switches, or rocker switches may be included to access volume control, for instance. But the preferred embodiment phone 10 has no alphanumeric keypad commonly found on conventional cell phones and smart phones that require finger presses or taps to dial a call, redial a number, hang up, etc.

The cell phone 10 lacks a keyboard of any sort and is entirely operated by voice command, via spoken words detected by the microphone 18. Further, since the phone 10 is intended to be voice controlled and interfaces with the user via audible language, there is no need for a video display. By omitting the keyboard and video display, power consumption is dramatically reduced. As is known in the art, the video display in a cell phone, smart phone, tablet, etc., generally consumes most energy, draining the battery quickly. Therefore, the size of the battery 24 can be reduced dramatically, and no space is needed on the phone 10 for a video display. The housing size is thus reduced. Omitting the keyboard and video display further reduces the weight. As a result, all cellular phone components can be squeezed into a housing the size of a conventional Bluetooth® ear piece, without the need of using Bluetooth® to tether the microphone and earpiece with the main body containing the transceiver, antenna, and power supply.

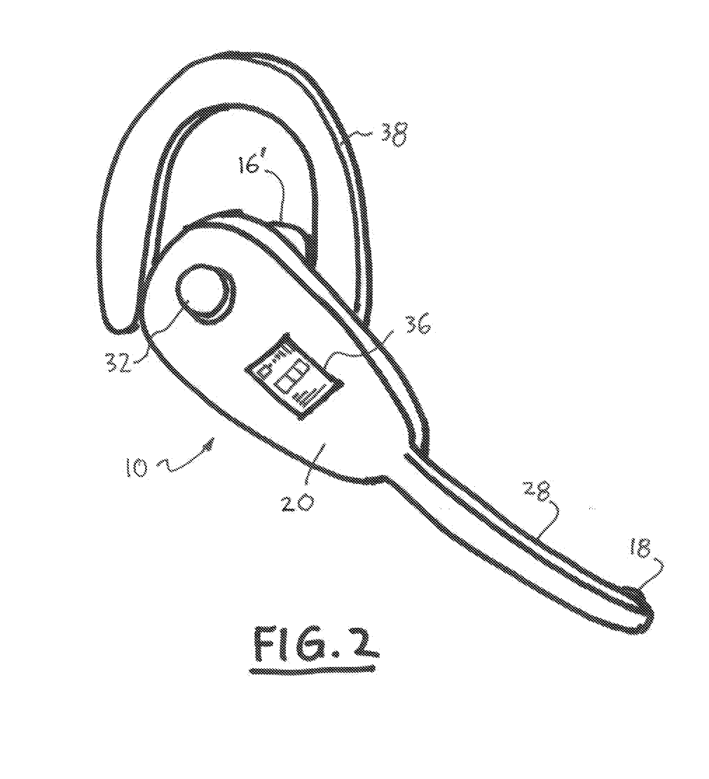

FIG. 2 is a perspective view of a preferred embodiment cell phone 10 having a cantilevered boom 28 with the microphone 18 embedded at the distal end. The entire cell phone 10 and all components are contained within or on the housing 20, except for the antenna and microphone held within the boom 28. An acoustic coupling 16′ can be an extension of speaker 16. It is made of silicone, neoprene, or soft, acoustic conduction material to be inserted into the user's ear canal. The coupling 16′ may further include a hook 38 that wraps around the user's ear to support the phone 10.

The main functions of the cell phone 10 are voice controlled. Voice control of basic cellular telephone functions is known, and disclosed in, for example, U.S. Pat. No. 6,532,447 (Christensson), titled “Apparatus and Method of Controlling a Voice Controlled Apparatus,” which contents are incorporated by reference. Thus, once the phone 10 is powered on or taken out of standby by activation of the on/off switch 32, the user can give voice commands to make an outgoing call, dial a specific phone number, look up a name in a contact list, and the like.

The preferred embodiment cell phone 10 being essentially voice controlled ideally interfaces a cloud based server 40 that contains voice recognition software, shown in FIG. 1. Through this mechanism, the user can have his or her incoming emails and SMS text message transcribed from a digital medium into audible language. By the same technique, the user via his or her cell phone 10 can dictate a reply or outgoing email or text message that will be transcribed to a digital medium and transmitted to the recipient. This is accomplished through the wireless call to the cell tower to the base station and then through the internet to the cloud 40. Using the cell phone 10 to access the cloud based server 40 is well known in the art, and can be performed by, for example, Voice Assist Inc., Lake Forest, Calif. (http://www.voiceassist.com/). Further examples include: voice dialing with automatically updated contact lists is disclosed in U.S. Patent Application Publication No. US2008/0037720 (Thomson, et al.); United States Patent Application Publication No. US2012/0052888 (Metcalf, et al.) discloses two-way texting through hosted applications, which is sending and receiving SMS text messages by voice; United States Patent Application Publication No. US2007/0189267 (Metcalf, et al.) discloses using an automated voice assistant between the client and a telephone number. All of the foregoing published U.S. applications are hereby incorporated by reference.

Therefore, it is possible to access any kind of internet based data including: the weather, stock prices, monthly calendars, etc. With the growing number of wireless or directly internet-connected devices, the voice command cell phone can control home appliances, automobiles start/stop, residential lighting, residential security, preheating ovens, using voice command to turn on/off, program, switch channels on cable or satellite box, etc. The cellular telephone can communicate with the cloud based server in order to use voice commands to dynamically change the display of web content on the internet. Examples are blogging with the phone user's voice, or changing the color of a web site.

In alternative embodiments, the singular cell phone can be connected to an additional ear piece to broadcast sound to both ears for listening to music, audio books, or other media requiring bi-aural sound. This can be done wirelessly or done with a head band worn on various positions on the head.

While particular forms of the invention have been illustrated and described, it will be apparent that various modifications can be made without departing from the spirit and scope of the invention. Features and components from one embodiment may be combined with another embodiment. Accordingly, it is not intended that the invention be limited except as by the appended claims.

I claim:

1. A cellular telephone worn on a user's head, the user having a mouth and an ear canal, the cellular telephone comprising:
a housing having a speaker engaging the user's ear canal, wherein the housing has no video display screen and no keypad;
a boom extending from the housing having a distal end extending toward the user's mouth;
a microphone disposed at the distal end of the boom;
an antenna extending along at least a portion of the boom;
a transceiver disposed within the housing connected to the antenna;
a battery disposed within the housing powering the transceiver;
a microprocessor including memory disposed in the housing and powered by the battery and controlling the transceiver, and interfacing with the speaker and microphone; and
voice recognition software resident in the microprocessor deciphering voice commands for the microprocessor to control telephone functions.

2. The cellular telephone of claim 1, wherein the housing includes an on/off switch connected to the microprocessor.

3. The cellular telephone of claim 1, wherein the housing includes a LCD display controlled by the microprocessor to display telephone information including at least one of cellular carrier signal strength, battery level, power on, and call connected.

4. The cellular telephone of claim 1, wherein the housing and boom are hinged so that the boom can be folded.

5. The cellular telephone of claim 1, wherein the housing includes a coupling containing the speaker, and wherein the cellular telephone is supported only by the coupling on the user's ear.

6. The cellular telephone of claim 1, wherein the cellular telephone accesses a cloud based server to transcribe at least one of incoming/outgoing emails, and incoming/outgoing text messages.

7. The cellular telephone of claim 1, wherein the cellular telephone accesses a cloud based server to use voice command to dynamically change the display of web content on the internet.

8. A cellular telephone worn on a user's head, the user having a mouth and an ear canal, the cellular telephone comprising:
a housing having a speaker engaging the user's ear canal, wherein the housing has no video display screen and no keypad;
a boom extending from the housing having a distal end extending toward the user's mouth;
a microphone disposed at the distal end of the boom;
an antenna extending along at least a portion of the boom;
a transceiver disposed within the housing connected to the antenna;
a battery disposed within the housing powering the transceiver;
a microprocessor including memory disposed in the housing and powered by the battery and controlling the transceiver, and interfacing with the speaker and microphone; and
voice recognition means resident in the microprocessor for digitizing voice commands to a control signal for the microprocessor to control telephone functions.

9. The cellular telephone of claim 8, wherein the cellular telephone accesses a cloud based server to transcribe at least one of incoming/outgoing emails, and incoming/outgoing text messages.

10. A cellular telephone worn on a user's ear, the cellular telephone comprising:
a housing having a speaker engaging the user's ear canal, wherein the housing has no video display screen and no keypad;
a boom extending from the housing having a distal end extending toward the user's mouth;
a microphone disposed at the distal end of the boom;
an antenna extending along at least a portion of the boom;
a transceiver connected to the antenna;
a battery disposed within the housing powering the transceiver;
a microprocessor including memory disposed in the housing and powered by the battery and controlling the transceiver, and interfacing with the speaker and microphone;
voice recognition means resident in the microprocessor for digitizing voice commands to a control signal for the microprocessor to control telephone functions; and
a cloud based server accessed by the cell phone to transcribe from an audible language to a digital medium and from a digital medium to an audible language for at least one of an incoming/outgoing email, and an incoming/outgoing text messages.

11. The cellular telephone of claim 10, wherein the transceiver is located in the boom at the distal end.
